(19) United States
(12) Patent Application Publication
(10) Pub. No.: US 2026/0007130 A1
(43) Pub. Date: Jan. 8, 2026

(54) SEED COMPOSITION AND RELATED METHODS OF MANUFACTURE AND USE

(71) Applicant: Donaghys Limited, Christchurch (NZ)

(72) Inventor: Karen Yeritsyan, Christchurch (NZ)

(73) Assignee: Donaghys Limited, Christchurch (NZ)

(21) Appl. No.: 19/048,505

(22) PCT Filed: Aug. 21, 2023
(86) PCT No.: PCT/NZ2023/050082

§ 371 Date: Feb. 7, 2025

(30) Foreign Application Priority Data
Aug. 25, 2022 (AU) 2022902431
Feb. 20, 2023 (AU) 2023900419
May 10, 2023 (AU) 2023901415

(51) Int. Cl. A01N 25/10; A01C 1/06; A01N 25/26; C05B 1/02; C08F 20/06; C08F 20/56; C08L 3/02; C08L 5/04; C08L 89/06; C09D 101/08

(52) U.S. Cl. CPC A01N 25/10; A01C 1/06; A01N 25/26; C05B 1/02; C08F 20/06; C08F 20/56; C08L 3/02; C08L 5/04; C08L 89/06; C09D 101/08

(57) ABSTRACT

Described herein is a seed composition comprising seed with a number of coatings and mixed with amphiphilic compound and hydrogel forming agent. The resulting seed composition which may be dry, is a single product configured to be storage stable and, when broadcast to a site, acts to deter or kill localised plant growth around the seed as defined by the agrochemical activity if agrochemical is present. The seed composition also supports nutrient levels and hydration about the seed resulting in high levels of subsequent seed germination. Related methods of manufacture and use are also described herein.

### RELATED APPLICATIONS

This application derives priority from Australian patent application number 2022902431 dated 25 Aug. 2022 with WIPO DAS number 6B6D; and Australian patent application number 2023900419 dated 20 Feb. 2023 with WIPO DAS number 4EC4; and Australian patent application number 2023901415 dated 10 May 2023 with WIPO DAS number F81F; all incorporated herein by reference.

### TECHNICAL FIELD

Described herein is a seed composition and related methods of manufacture and use. More specifically, a seed composition is described comprising seed with a number of discrete coatings. Related methods of manufacture and use are also described.

### BACKGROUND ART

Seed coatings and mixtures to confer properties to seed are widely used in the prior art. The coatings and mixtures may include a variety of compounds including active agents such as agrochemical compounds. For the purposes of this background description, herbicides as the agrochemical compound are referred to however, other agrochemical compounds may be used for the seed composition and methods described herein or instead, no agrochemical compound may be used.

Herbicidal compositions are generally aqueous solutions typically as concentrates of a particular herbicide compound mixed with solvent(s) and excipients. Such compositions have known limitations around handling (spray drift, dilution at application) and shear weight and volume leading to effectively paying to transport and store water or other solvents along with the herbicide. Stability of liquid herbicide compositions is also an issue addressed in the art using many different additives solvents, co-solvents, stabilisers and so on. Whilst many of these art solutions may be useful e.g. to increase the concentration of herbicide in the compositions yet avoid separation, they introduce extra manufacturing steps, extra manufacturing costs and so on beyond just suppling the herbicide itself. As one example, glyphosate is a well-known and widely used herbicide. Glyphosate, however, requires prior reaction to a salt form before manufacture into a concentrate so that the glyphosate is liquid soluble.

Art herbicidal seed compositions are quite unusual and then, only dried and supplied for storage purposes. That is, the herbicide is not used or applied in a dry form but instead typically mixed with a liquid e.g. water, immediately prior to broadcast. Whilst dry storage may address transport and storage issues of liquid formulations, the step of mixing before broadcast detracts from the product versatility—indeed, dissolving some herbicides can be difficult in a purpose built facility let alone in situ at a farm or residential home. Another drawback of art herbicidal dry compositions are that they are known to have handling issues from dust. As a result of dust formation, the user needs to be careful not to breathe the dust and not to have dust blow away from target broadcast areas. As a result, liquid concentrates tend to dominate the market for herbicides however, liquid concentrates also have spray drift issues akin to dust spread.

A further aspect of art herbicide compositions is that they are almost always exclusively formulated for and directed for foliar application to plants. Alternative modes of delivery such as to the ground surface or into the ground via for example drilling is to the inventor's understanding not completed or at least not completed to a commercial scale. This is understood to be because art products almost exclusively being liquid concentrates, have poor efficacy from ground broadcast.

Art herbicide compositions are also generally single active formulations or less commonly, herbicide combinations generally using chemically compatible herbicides. There may be stability or commercial reasons for single or compatible combinations however, this does create more work. For example, in a pasture renewal scenario, a farmer has to apply herbicide and then again at a later date re-seed the ground and optionally later again apply fertiliser or minerals. For a small land area, the cost of multiple applications in labour and materials may be minor or an inconvenience however, the large land areas and for isolated land areas, multiple applications may make this process uneconomic. In the context of farming, high costs limit the amount of land able to be used for food production. The same principles would apply for other land uses like forestry and conservation land development and growth. Reducing the number of applications through combination broadcast of for example a fertiliser or mineral and herbicide (and even seed) may have a huge impact on cost/returns.

A yet further drawback of many art herbicide compositions is that they can only be applied during dry weather. Application when rain occurs or when rain is predicted prevents broadcast since the rain may wash or dilute the herbicide therefore reducing dose rates to vegetation and, in worst cases, resulting in run off of herbicide into the environment such as water ways.

A yet further challenge is how to provide seeds with an initial competitive advantage at germination. Simply mixing seed and liquid herbicide for example at broadcast kills both existing plant matter as well as preventing seed germination and subsequent growth.

Some specific examples of seed combinations and the differences they have to that further described herein are now commented on below.

US2022/0007640A1 does not have a film coating and binder present (only a pelletiser).

US2022/0007640A1 has a hydrogel but this is mixed into the pelletiser coating and not used as a discrete separate coating to a first coating and amphiphilic layer or, not used as a discrete separate coating to a first coating. US2022/0007640A1 does not describe application of an amphiphilic coating directly to a seed.

US2010/0267554A1 does not have a film coating and binder present (only a pelletiser).

US2010/0267554A1 uses a hydrogel as a discrete further layer that is not mixed with a seed that has already been coated with a first coating and subsequent amphiphilic coating or, is not mixed as a discrete separate coating to the initial coating and amphiphilic coating. Further, US2010/0267554A1 does not describe application of amphiphilic compound directly to a seed as a first coating.

CN108575190A describes a composition with four discrete layers-pelletiser, then amphiphilic compound, then hydrogel, then agrochemical. There is no use of a film coating and binder also with the pelletiser. In addition, CN108575190A does not describe application of amphiphilic compound directly to a seed as a first coating.

U.S. Pat. No. 9,596,801 B2 has three discrete layers. U.S. Pat. No. 9,596,801 B2 requires a first layer of hydrogel, then active, then pelletiser. Amphiphilic compound is not present at all in U.S. Pat. No. 9,596,801 B2. The agrochemical compound is under a pelletiser layer in U.S. Pat. No. 9,596,801 B2. Further, binding agent is specifically excluded in U.S. Pat. No. 9,596,801 B2.

The above described compositions lack certain key compounds or coatings or coating order on a seed found to be useful by the inventor to easily manufacture and successfully grow new plants from seeds with the benefits described for the seed composition and methods described herein.

It may be of benefit to address at least some of the above art issues and problems or at least provide the public with a choice.

Further aspects and advantages of the seed composition and related methods of manufacture and use will become apparent from the ensuing description that is given by way of example only.

### SUMMARY

Described herein is a seed composition comprising seed from a plant, a first coating on the seed comprising: a pelletising agent and optionally also a film coating agent, a binding agent or both a film coating agent and a binding agent, a second coating over the first coating comprising an amphiphilic compound, and hydrogel forming agent mixed with but not embedded in the first coating or the second coating. An alternate seed composition is also described comprising seed with a first coating of an amphiphilic compound and a second coating comprising pelletising agent and optionally also, a hydrogel forming agent. The resulting seed composition is a single product configured to be storage stable and, when broadcast to a site, acts to deter or kill localised plant growth around the seed as defined by the agrochemical activity. The seed composition also supports nutrient levels and hydration about the seed resulting in high levels of subsequent seed germination. Related methods of manufacture and use are also described herein.

In a first aspect, there is provided a seed composition comprising:
seed from a plant;
a first coating on the seed, the first coating comprising: a pelletising agent and optionally also a film coating agent, a binding agent or both a film coating agent and a binding agent;
a second coating over the first coating, the second coating comprising an amphiphilic compound, the second coating configured to form a discrete layer over the first coating, the amphiphilic compound configured to delay release of the first coating and seed from the seed composition, post application/broadcast of the seed composition to a substrate; and
hydrogel forming agent, the hydrogel forming agent being a separate component mixed with but not embedded in the first coating or the second coating.

In a second aspect, there is provided a seed composition comprising:
seed from a plant;
a first coating on the seed, the first coating comprising an amphiphilic compound, the seed and first coating forming a coated pellet or granule; and
a second coating over the first coating, the second coating comprising: a pelletising agent and a hydrogel forming agent, the second coating being a discrete layer over the first coating.

Optionally, in the above aspects, the seed composition may further comprise an agrochemical. The agrochemical may, in the first aspect comprise a third coating over the seed composition hydrogel forming agent and amphiphilic coated pellet or granule. The agrochemical in the second aspect may be mixed with the at least one pelletising agent and at least one hydrogel forming agent as part of the second coating.

In a third aspect, there is provided a method of manufacturing a seed composition by:
selecting seed from a plant;
coating the seed with a first coating, the first coating comprising: a pelletising agent and optionally also a film coating agent, a binding agent or both a film coating agent and a binding agent;
coating the seed with a second coating over the first coating, the second coating comprising an amphiphilic compound to form a double coated seed; and
providing a hydrogel forming agent and mixing the hydrogel forming agent with the double coated seed, the hydrogel forming agent mixed with but not embedded in the first coating or the second coating on the seed.

Optionally, the above method may further comprise drying the seed composition to form a dry seed composition.

Optionally, prior to drying, the method may further comprise coating the second coating of the seed composition, with a third coating, the third coating comprising agrochemical compound.

In a fourth aspect, there is provided a method of manufacturing a seed composition by:
selecting seed from a plant;
coating the seed with a first coating, the first coating comprising an amphiphilic compound; and
coating the seed with a second coating over the first coating, the second coating comprising a pelletising agent and optionally also a hydrogel forming agent, the second coating forming a discrete layer over the first coating.

Optionally, the above method may further comprise drying the seed composition to form a dry seed composition.

Optionally, prior to drying, the method may further comprise coating the second coating of the seed composition, with a third coating, the third coating comprising at least one agrochemical compound.

In a fifth aspect, there is provided a method of shipping, or storing, or shipping and storing, a seed composition by:
forming the seed composition substantially as described above and, optionally drying the seed composition; and
shipping, or storing, or shipping and storing, the seed composition in a dry state.

In a sixth aspect, there is provided a method of broadcasting a seed composition by:
selecting the seed composition substantially as described above;
storing the seed composition until ready for use; and
applying the seed composition onto or into a ground surface.

In a seventh aspect, there is provided a method of seeding land comprising:
providing a volume of seed composition substantially as described above;
optionally, transporting and storing the seed composition; and
broadcasting the seed composition onto or into land to be seeded.

The seed composition and related methods of manufacture and use may provide a number of advantages over the art. One selected advantage may be the ability to produce a stable dry seed composition with agrochemical effects and growth nutrients and water retention capability all in a single product form. These properties may preferentially allow and support high seed germination and growth rates from the seed. More advantages are described and may be apparent from the detailed description below.

### BRIEF DESCRIPTION OF THE DRAWINGS

Further aspects of the seed composition and related methods of manufacture and use will become apparent from the following description that is given by way of example only and with reference to the accompanying drawings in which:

FIG. 1 illustrates a stylised drawing of a seed composition as manufactured with part of the exterior removed to show the interior structure according to a first aspect;

FIG. 2 is a photograph of a seed composition produced from the method described in Example 4;

FIG. 3 is a photograph showing the extent of seed germination post the trial described in Example 5;

FIG. 4 shows photographs of ground to which the seed composition was applied before broadcast (left) and 4 weeks post broadcast (right) as described in Example 6;

FIG. 5 is a photograph showing the way the hydrogel remains loosely associated with the seed and swells and retains moisture about the seeds as described in Example 7;

FIG. 6 shows a photograph on the left of the seed composition prior to addition of potable water while the photograph on the right shows the seed composition and potable water combination approximately 15 minutes after water exposure as described further in Example 8;

FIG. 7 illustrates a stylised drawing of a seed composition as manufactured with part of the exterior removed to show the interior structure according to a second aspect;

FIG. 8 is a photograph of a seed composition produced from the method described in Example 10 at day 0; and,

FIG. 9 is a photograph of a seed composition produced from the method described in Example 10 at day 4.

### DETAILED DESCRIPTION

As noted above, described herein is a seed composition comprising seed from a plant, a first coating on the seed comprising: a pelletising agent and optionally also a film coating agent, a binding agent or both a film coating agent and a binding agent, a second coating over the first coating comprising an amphiphilic compound, and hydrogel forming agent mixed with but not embedded in the first coating or the second coating. An alternate seed composition is also described comprising seed with a first coating of an amphiphilic compound and a second coating comprising pelletising agent and optionally also, a hydrogel forming agent. The resulting seed composition is a single product configured to be storage stable and, when broadcast to a site, acts to deter or kill localised plant growth around the seed as defined by the agrochemical activity. The seed composition also supports nutrient levels and hydration about the seed resulting in high levels of subsequent seed germination. Related methods of manufacture and use are also described herein.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

The term ‘separate’ or ‘discrete’ and grammatical variations thereof in the context of coatings or layers described herein, refers to different layers with no or substantially no mixing or homogeneity between the coatings or layers.

The term ‘mix’ and grammatical variations thereof described herein refers to the compound or compounds noted being substantially blended together.

The term ‘seed’ or grammatical variations thereof refers to a propagative part of a plant.

The term ‘seed coating’ or grammatical variations thereof as used herein refers to layer that may directly or indirectly substantially cover the exterior surface of a seed and which comprises one or more compounds as described further herein.

The term ‘film coating agent’ or grammatical variations thereof as used herein refers to a seed film coating agent mixture or formulation comprising a variety of compounds configured to enhance seed and seeding propagation and growth. A film coating agent as used herein is different to a seed coating in that a seed coating need not have film coating agent present and, if film coating agent is present, the film coating agent may be one of several compounds used to form the seed coating described.

### Seed Composition

In a first aspect, there is provided a seed composition comprising:
seed from a plant;
a first coating on the seed, the first coating comprising: a pelletising agent and optionally also a film forming agent, a binding agent or both a film forming agent and a binding agent;
a second coating over the first coating, the second coating comprising an amphiphilic compound, the second coating configured to form a discrete layer over the first coating, the amphiphilic compound configured to delay release of the first coating and seed from the seed composition, post application/broadcast of the seed composition to a substrate; and
hydrogel forming agent, the hydrogel forming agent being a separate component mixed with but not embedded in the first coating or the second coating.

In a second aspect, there is provided a seed composition comprising:
seed from a plant;
a first coating on the seed, the first coating comprising an amphiphilic compound, the seed and first coating forming a coated pellet or granule; and
a second coating over the first coating, the second coating comprising: a pelletising agent and a hydrogel forming agent, the second coating being a discrete layer over the first coating.

### Single Product

The seed composition may be a single product. There is no need to mix or co-apply multiple agents or products with the seed composition. The seed composition described has all properties needed to support the seed during transport and storage and in for subsequent germination post broadcast. The seed composition may be configured to be storage stable. Assuming the seed composition is dried and kept dry, the seed composition may be stored for extended periods of time and then still have high (>90%, or 95%, or 96%, or 97%, or 98%, or 99%) germination rates post broadcast.

The seed composition may be configured so that, when broadcast to a site, the seed composition acts to deter or kill localised plant growth around the seed as defined by agrochemical activity assuming the seed composition comprises an agrochemical compound.

The seed composition may support nutrient levels about the seed. The nutrient levels may be provided to the soil about the seed and/or to the seed itself as vegetation nutrition. This nutrient support aspect may depend on the seed coating or seed coatings chosen.

### Seed

Reference is made to the word ‘seed’ herein to mean a single seed or multiple seeds i.e. singular or plural. Seed as noted is derived from a plant and is plant propagative material.

The seed may be a seed selected from: an agricultural crop, a seed used in forestry, a native plant or plants, and combinations thereof. In the inventor's experience almost any type of seed may be used to form the seed composition and the specific seed types noted may be more relevant commercially but the seed composition described may encompass other seed types.

The agricultural crop may be seed grass or forage seed. The seed composition described herein may be used to extend or re-sow arable land. By way of example, use of the seed composition in agriculture may be a way to cost effectively increase the quantity of land available for grazing by livestock.

The seed may be a seed used in forestry. For example, the seed used may be pine seed. The pine seed or other forestry seed may be used to cost effectively plant an area of forestry block land.

The seed may be from a native plant or plants. The seed in this case may be used to extend native forest land and conservation estate.

Specific examples of seed that may be used to form the seed composition may comprise: cocksfoot seeds, white clover seeds, plantain seeds, ryegrass seeds, rape seed, turnip seed, and combinations thereof.

### Seed Coating

The first coating, or the second coating, or any subsequent coating if used, may substantially cover the exterior surface of seed. The first coating, or the second coating, or any subsequent coating if used, may alone (i.e. one coating) or together (all of the coatings used) entirely cover or coat the seed.

The first coating or the second coating or both the first and the second coatings may be configured to delay seed germination. This action is common to many commercially available seed coatings either by design or as a by-product of the seed coating compounds used.

### Pelletising Agent

The pelletising agent, may be selected from: chalk, lime, calcium carbonate, clays, bentonite, cellulose, talc, kaolin and combinations thereof.

### Film Coating Agent

The seed composition may comprise at least one film coating agent.

The film coating agent may be selected from art seed film coating agent formulations. Examples may be those sold under the trade marks: Peridiam™ or Polyselect™ or Seedguard™, Superstrike™, Prillcote™, Agricote™, Ultrastrike™, Force Field™, Gaucho™, Poncho™, AgroKoat F™, and AgroKoat A™. Other examples of film coating agents may be selected from starches, gums, sugars, cellulose and combinations thereof.

An advantage of utilising art seed film coating agents may be to take advantage of proprietary insecticides and/or fungicides that remove the necessity of adding these compounds separately to the first coating, or the second coating, or the seed composition.

Note that the film coating agent described herein is distinct from a seed coating. A seed coating may have multiple components beyond just a film coating agent as defined further above.

### Binding Agent

The binding agent if used, may be selected from: modified cellulose, polyvinyl pyrrolidone, polyvinyl alcohol, and combinations thereof. One example of a suitable binding agent may be hydroxypropyl methylcellulose.

### Coating Exclusions

In the above first aspect, the second coating of the seed composition may not comprise a film coating agent, a binding agent, or a pelletising agent.

In the above second aspect, the first coating of the seed composition may not comprise a pelletising agent or a hydrogel forming agent.

As may be appreciated from the above, the first and second coating layers may be discrete and components in one coating may not embed or mix with the other coating.

### Further Coating Compounds

The seed may optionally be coated or mixed with further compounds. The further compounds if used, may comprise at least one: fertiliser, mineral, insecticide, fungicide, macro-and micro-element, plant growth-promoting bacteria, rhizobia, inoculant, granulation additive, germination promotion additives, and combinations thereof.

The fertilisers or minerals may be selected from: lime, urea, phosphate, phosphate salts, super phosphate, ammonium sulphate, NPK, NPKS, magnesium oxide, gypsum, and combinations thereof. The fertiliser or mineral compounds noted above may be useful as they may act as a carrier for agrochemicals and also have a nutrient effect as well. As a result, the fertiliser or mineral compounds noted may act as a growth promotor for the seed in the seed composition post broadcast to a substrate. Selection of the fertilisers or minerals may depend on the agrochemical properties and application requirements for the seed or substrate to which the seed may be broadcast. For example, lime may be chosen for acidic soils and magnesium oxide may be chosen for soils with magnesium deficiency.

The insecticide if used, may be Keyrole Pro™. This commercially available insecticide uses clothianidin as the active.

The inoculant if used, may be peat. Other soil inoculants may also be used.

### Coating Volume

The first coating or, the second coating or, a combination of seed coatings, may comprise 2 to 99.8% by weight of the seed composition.

### Amphiphilic Compound

As noted above, the seed composition comprises an amphiphilic compound.

The amphiphilic compound may be configured to delay release of the seed, or the first coating, or the second coating from the seed composition post broadcast to a substrate.

In the above first aspect, the first coating may not comprise an amphiphilic compound. That is, the amphiphilic compound is only in the second coating of the seed composition.

In the above second aspect, the second coating may not comprise an amphiphilic compound. That is, the amphiphilic compound is only in the first coating of the seed composition

The amphiphilic compound may be formulated as a: liquid, solid; a supersaturated suspension, or an emulsion.

The amphiphilic compound may further have emulsifying properties.

The amphiphilic compound may be: water soluble; water absorbing; attractive to moisture; water dispersible; at least partly hygroscopic; and combinations thereof.

The amphiphilic compound may be a synthetic or a natural molecule.

The amphiphilic compound may self-assemble into a wide variety of structures including liposomes, bilayer sheets, micelles, vesicles, nanotubes, nanofibers, and lamellae or combinations thereof. The exact structure of self-assembly may be dependent on depending on hydration and temperature.

The amphiphilic compound may be a phosphoglyceride or phosphotide compound. These are compounds may be selected from the group of yellow-brownish fatty substances occurring in animal and plant tissue.

The amphiphilic compound may be present as mixtures of glycerophospholipids. For example, the amphiphilic compound may be a mixture of two or more of the following compounds: phosphatidylcholine, phosphatidylethanolamine, phosphatidylinositol, phophatidylserine, phosphatidylglycerol and phosphatidic acid.

The amphiphilic compound may be selected from: lecithin; hydrogenated lecithin; lysolecithin; hydrogenated lysolecithin; phospholipids; hydrolysed phospholipids; phosphatidic acid; lysophosphatidic acid; phosphatidylglycerol; lypophosphatidylglycerol; phosphatidylserine; ammonium phosphatidyl rapeseedate; phosphatidylcholine; hydrogenated phosphatidylcholine; hydrogenated lysophosphatidylcholine; lysophosphatidylethanolamine; phosphatidylositol; and combinations thereof.

Specific examples of the amphiphilic compound that may be used may comprise: soy lecithin, phosphatidylositol, and ammonium phosphatidyl rapeseedate.

Lecithin was identified by the inventor as a useful amphiphilic coating compound. Lecithin is a generic term to designate any group of yellow-brownish fatty substances occurring in animal and plant tissues or complex mixture of glycerophospholipids obtained from animal, vegetable or microbial sources, containing varying amounts of substances such as triglycerides, fatty acids, glycolipids, sterols, and sphingophospholipids

The lecithin if used may be natural or synthetic. In naturally occurring lecithin, the phosphoric acid is attached to the glycerol at the a-position. However, the phosphoric acid may also be attached in the β-position of glycerine, as a by-product of synthesis;

The amphiphilic compound may comprise 0.01 to 50%, or about 0.02 to 10%, or about 0.05 to 5%, or about 0.1 to 2% by weight of the seed composition.

### Hydrogel Forming Agent

The hydrogel forming agent may be configured to swell and absorb water, saline solutions or physiological fluids. The hydrogel forming agent may form a three dimensional network when it swells. The hydrogel forming agent may swell as much as 10-1000 times its own weight.

The hydrogel forming agent may be naturally derived or synthetically derived.

Naturally derived hydrogel forming agents may be selected from: cellulose, starch, chitosan, gelatine, collagen, alginate and combinations thereof. Natural hydrogel polymers may be divided into two groups: proteins (collagen, gelatine, etc.) and polysaccharides (starch, alginate, agarose, etc.). Other options may include bentonite and colloidal silica. All of these types of hydrogel forming agent may be used as part of the above described seed composition.

Synthetically derived hydrogel forming agent may be selected from polymers based on polyacrylic acid and polyacrylamide.

Selected specific examples of suitable hydrogel forming agents may comprise: potassium polyacrylate, polyaspartic acid, gelatin, sodium alginate, starch, and sodium polyacrylate.

The hydrogel forming agent may comprise 0.1 to 99%, or from 0.2-90%, or from 0.5-45% by weight of the seed composition.

The hydrogel forming agent may be partly bound to the seed composition. That is, the hydrogel forming agent may be only loosely attached or merely mixed with the seed in the seed composition.

The hydrogel forming agent prior to broadcast may be or un-hydrated and at a reduced size. Post broadcast and on hydration post broadcast, the hydrogel forming agent may subsequently swell and retain environmental moisture. When this happens, the seed composition and hydrogel forming agent may separate or become only loosely associated together. In the inventor's experience, the seed composition remains close to, or adjacent, or within, the hydrated hydrogel forming agent post broadcast. This loose association in the inventor's experience provides the seed with sufficient moisture to germinate and grow, with the very high (>90%) level of germination success observed.

### Agrochemical

Optionally, in the above aspects, the seed composition may further comprise an agrochemical.

The agrochemical compound may, in the first aspect comprise a third coating over the second coating of the seed composition.

In the above first aspect, the first coating and the second coating of the seed composition may not comprise an agrochemical compound.

In the above second aspect, the first coating may not comprise an agrochemical compound.

The agrochemical compound in the second aspect may be mixed with the at least one pelletising agent and at least one hydrogel forming agent as part of the second coating.

The agrochemical compound if used, may be a compound with herbicide, fungicide, or insecticide properties. As may be appreciated, whilst the seed composition may be a useful carrier for an agrochemical compound, inclusion of an agrochemical compound with the seed composition is not essential. The seed composition described may provide a number of useful benefits to seed propagation even without agrochemical compound present. Reference to the presence of agrochemical compound herein should not be seen as limiting.

The type of agrochemical compound selected (or types of agrochemical compound selected for mixtures) may be based on the type of plants or ‘pests’ to be controlled.

For example, the agrochemical compound may be configured to control un-desirable plants or pests in the immediate surroundings of the applied seed only. For example, to provide localised control of the plants or ‘pests’ to assist with successful germination of applied seeds, and not for general control of undesired vegetation or pests (for example in case of foliar application of glyphosate soluble concentrates, full control of whole area is expected). This is achieved by “clearing” the immediate area about the seed from competing established vegetation and preventing pests from damaging the applied seeds. The immediate area is this case may be a circumferential area greater than 1, or 2, or 3, or 4, or 5, or 6, or 7, or 8, or 9, or 10 mm from the seed itself.

The herbicide if used may be a non-selective herbicide or a selective herbicide. The herbicide may be a contact herbicide active. The herbicide may have activity against broadleaf weeds, brush weeds, gorse, broom, and thistles. The herbicide may be soluble and/or able to be emulsified in aqueous solutions or other solvents. The herbicide may be in salt form.

Examples of agrochemical compounds that may be used comprise: glyphosate soluble concentrate, metsulfuron-methyl, 2,4-D emulsifiable concentrate, flumetsulam. Specific herbicides that could be used may be selected from: glyphosate (glycine's, group M (inhibitors of EPSP hormone) or group 9 (aromatic amino acid inhibitors), glyfosinate, glyfumesate, desmedipham, phenmedipham, MCPB, bentazone, dicamba, flumetsulam, phenoxy herbicides; 3,5,6-Trichloro-2-pyridinyloxyacetic acid; picolinic acid herbicides; and combinations thereof.

The phenoxy herbicides described above may be 2,4-D and 2-methyl-4-chlorophenoxyacetic acid commonly known as MCPA.

3,5,6-Trichloro-2-pyridinyloxyacetic acid described above may also be termed or commonly known as triclopyr.

The picolinic acid herbicides described above may be 3,6-dichloro-2-pyridinecarboxylic acid commonly known as clopyralid.

As may be appreciated, the seed composition described may be highly versatile and many different types of agrochemical compound may optionally be used, the agrochemical compounds chosen potentially having different types of activity.

The seed composition may comprise sufficient concentration of agrochemical compound to be herbicidally effective, fungicidally effective, or insecticidally effective when broadcast to a substrate. The exact concentration of agrochemical compound used in the seed composition may vary depending on factors such as: the type of film coating agent used, the manufacturing process used e.g. concentration of agrochemical compound relative to film coating agent quantities in the seed composition.

The concentration of agrochemical compound used may for example, compare with standard amounts of agrochemical compound application per area for traditional liquid and foliar applied agrochemical compound products. By way of example, a standard spray application rate in New Zealand of glyphosate may be 1440-1450 g/ha, so the seed composition described may comprise seed granules in amount to cover 1 ha and in total to contain 1440 g of glyphosate hence has a comparable concentration or herbicide loading to art aqueous spray application concentrations. Other countries may have alternative spray application rates. This application rate may be used to govern the concentration of herbicide incorporated with the seed composition.

In one example, the agrochemical compound may comprise 0.1 to 60% by weight of the seed composition.

### Multiple Agrochemical Compounds

More than one type of agrochemical compound may optionally be used in the seed composition. This may be useful to allow co-application of multiple types of agrochemical compound in one product and one application.

Where multiple agrochemical compounds are used, the agrochemical compounds selected may have a similar activity. Alternatively, the agrochemical compounds chosen may have different activities.

For example, the seed composition may comprise two herbicides as the agrochemical compounds, a first herbicide with selective properties to certain species of plant while the second herbicide used may also be selective but to other species of plant to the first herbicide used. Alternatively, a first herbicide used may be selective and a second herbicide used may be non-selective.

Agrochemical Compound Location/Absorbtion The agrochemical compound coating may remain substantially on the outer surface of the seed composition. A discrete separation may exist between the agrochemical compound and other layers of the seed composition. The agrochemical compound coating may not be homogenous with other coatings or layers of material used. The agrochemical compound coating may be a discrete separate layer on the seed composition exterior.

### Dry

The seed compositions described herein may be dry seed compositions. The above seed compositions may be dried to reduce the water activity of the seed compositions.

In the context of this specification, the term ‘dry’ may refer to a water activity of less than 0.7, or 0.6 or 0.5, or 0.4 or 0.3, or 0.2, or 0.1. Alternatively, the term ‘dry’ may refer to a moisture content of the dry seed composition being less than 10%, or 9%, or 8%, or 7%, or 6%, or 5% by weight.

As may be appreciated, the residual water content of the dry seed composition may be low or very low.

As a result, the dry seed composition may be formulated as a particle, dust, powder, cake, prill or granular composition. For ease of description, granules or pellets may be referred to in this specification however, this is not intended to exclude other formulations or forms. The dry seed composition shape may be largely determined by the size and shape of the seed itself on which the other layers are applied. The coated pellets or granules may have an average size from 0.2 to 2 mm although this size and size distribution may vary considerably.

The dry seed composition may be stored prior to use in a sealed bag or container to avoid contact with moisture and elution. The dry seed compositions described may be hydroscopic. As a result, storage in a sealed enclosure may be useful to prevent absorbtion of moisture prior to broadcast.

### Elution

The seed composition may be configured to readily elute once broadcast to a substrate and exposed to moisture.

Moisture in the context of action post broadcast may be in the form of rain, irrigation, dew, humidity, and combinations thereof. Even minor amounts of water such as that obtained from night or morning dew or humid ambient conditions may be sufficient in the inventor's experience to cause elution. The hydrogel forming agent appears to greatly improve seed germination by absorbing water in the environment and keeping this available near, or beside, or around seed as the seed germinates.

### Rate of Seed Composition Breakdown

The coatings applied to the seed to form the seed composition may be configured to act to release the different layers and compounds in stages or steps when the seed composition is broadcast to a substrate.

The amphiphilic compound chosen may itself confer a rate of release to the seed composition once broadcast. This rate may be governed by the elution rate of the amphiphilic compound itself post broadcast.

The rate of release or elution rate of the first, second or further coatings or amphiphilic compound or both the coating(s) and amphiphilic compound may be adjusted. Adjustment may be achieved by use of additives mixed with the seed coatings described, by choice of film coating agent (if used) or by choice of amphiphilic compound. The additives may be selected based on their ability to change the release/elution characteristics of the seed coating or amphiphilic compound.

In one embodiment for example, adding high HLB surfactant (HLB>10) to lecithin will create a coating with rapid (˜2 hours) release. Alternatively, by adding low water solubility solid additives, for example binding agents such as calcium carbonate or clays to the film coating agent, it is possible to produce a slow release (12-24 hours) seed composition. Clays generally, such as bentonite clays, may be useful elution rate adjustor compounds. This may be due to their ability to absorb water and then slowly release it and therefore delay the rate of elution.

The inventor has found that, by use of additives, the rate of breakdown of the seed composition post broadcast may be varied from a rapid release to a slow release. The rate of release may be varied from being one bolus amount (e.g. all elution completed after 2 hours post contact with water/moisture); or as a dosed constant rate of release over time; or as a variable rate of release over time. The degree of tuning in the rate of breakdown of the seed composition may provide a wide degree of product versatility.

### Soil Broadcast

The seed composition may be formulated for direct foliage or soil application.

As noted above, the seed composition may enable delivery of agrochemical compound via soil to roots of vegetation. Typically, agrochemicals such as herbicides are applied to the foliage of plants and not applied via soil. The inventor found that the seed composition described above, when drilled or otherwise applied to soil, had a herbicidal effect on plants in the soil. This result was unexpected and useful in this case to reduce competition for growth of seeds broadcast in the seed composition.

### Flaking Off or Dusting

The problem in the art of ‘flaking off’ or ‘dusting’ and associated negative effects of loss of enclosed agrochemical on carriers may be addressed by this seed composition particularly when the seed composition is dried. The described coatings and method of manufacture described further below avoids flaking off or dusting observed in the art. This may eliminate or significantly reduce a long standing problem in art for formulations of this nature avoiding these issues and hence improving product handling and product longevity.

Seed Germination Rate The seed composition on broadcast may have a 90, or 91, or 92, or 93, or 94, or 95, or 96, or 97, or 98, or 99, or 100% rate of germination as measured in laboratory condition. In the inventor's experience, even in field environments, this observed germination rate remains consistent, being surprisingly high.
Seed Composition Shelf Life The shelf life of dried seed composition may be determined by the shelf life/activity of seeds i.e. the dry seed composition may have no effect on seed viability even when stored for prolonged periods of time.

Trials completed by the inventor have shown more than 90% germination of rye grass seed from a dry composition and ryegrass seed combination post storage together. This clearly shows no compromise in germination from mixing and storage of the seed composition described above.

This inert nature of the seed composition is somewhat counter intuitive in that the seed composition comprises agrochemical such as herbicide that is designed to kill plant growth and yet the seed has such a high observed germination rate. Without being bound to a specific mechanism, it appears that the agrochemical compound once coated to the seed composition does not interact with the seed in the seed composition during storage. Further, elution and agrochemical effects post elution appear to occur rapidly enough post broadcast so as to cause surrounding vegetation or pests to be impacted but to not impact seed germination and growth. The localised agrochemical effect allows the seed to germinate and grow with less or no competition from existing vegetation or pests thereby allowing the new plant to become established ahead of competitive plant growth.

### Method of Manufacture of a Composition Comprising

In a third aspect, there is provided a method of manufacturing a seed composition by:
selecting seed from a plant;
coating the seed with a first coating, the first coating comprising: a pelletising agent and optionally also a film coating agent, a binding agent or both a film coating agent and a binding agent;
coating the seed with a second coating over the first coating, the second coating comprising an amphiphilic compound to form a double coated seed; and
providing a hydrogel forming agent and mixing the hydrogel forming agent with the double coated seed, the hydrogel forming agent mixed with but not embedded in the first coating or the second coating on the seed.

### Drying and Agrochemical Addition

Optionally, the above third aspect method may further comprise drying the seed composition to form a dry seed composition.

Optionally, prior to drying, the above third aspect method may further comprise coating the second coating of the seed composition, with a third coating, the third coating comprising agrochemical compound.

In a fourth aspect, there is provided a method of manufacturing a seed composition by:
selecting seed from a plant;
coating the seed with a first coating, the first coating comprising an amphiphilic compound; and
coating the seed with a second coating over the first coating, the second coating comprising a pelletising agent and a hydrogel forming agent. the second coating forming a discrete layer over the first coating.

### Drying and Agrochemical Addition

Optionally, the above fourth aspect method may further comprise drying the seed composition to form a dry seed composition.

Optionally, prior to drying, the above fourth aspect method may further comprise coating the second coating of the seed composition, with a third coating, the third coating comprising at least one agrochemical compound.

### Coating and Mixing

The process of coating described above may be via methods such as: mixing, rolling, or dipping the seed and other compounds/layers/agents described above together to form the seed composition.

Mixing with hydrogel forming agent may be a step of mixing, rolling, or dipping the amphiphilic coated seed and hydrogel forming agent together.

### Spraying

The step of coating the amphiphilic coated seed and hydrogel forming agent mixture with agrochemical may be completed by spraying the agrochemical compound onto the amphiphilic coated seed and hydrogel forming agent mixture.

Spraying may be completed by mixing the agrochemical compound with water or other aqueous or non-aqueous solution/solvent at a desired concentration.

Sprayers such as atomisers and pressure sprayers may be used to complete the spraying.

### Drying

Drying as noted above may use processes such as dry heat application, freeze drying, vacuum drying, spray drying and so on.

The water activity of the dry seed composition after drying may be less than 0.7, or 0.6 or 0.5, or 0.4 or 0.3, or 0.2, or 0.1. The moisture content of the dry seed composition after drying may be less than 10%, or 9%, or 8%, or 7%, or 6%, or 5% by weight.

### Method of Shipping and Storing

In a fifth aspect, there is provided a method of shipping, or storing, or shipping and storing, a seed composition by:
forming the seed composition substantially as described above and, optionally drying the seed composition; and
shipping, or storing, or shipping and storing, the seed composition in a dry state.

The seed composition described above may provide a storage stable and dry method of shipping and storing a seed composition ready for broadcast. Typically seed, seed film compositions, and agrochemicals such as herbicides are often shipped separately and stored in liquid concentrate form. In the art, the issue is that agrochemical compounds in particular are usually concentrates, therefore they need to be diluted before use. The seed composition described herein once dried, does not comprise water or liquid hence the weight/volume for transport is reduced. Further, dilution steps on application are avoided since the dry seed composition is broadcast in the form provided and does not require dilution. Another advantage is that normally herbicides and fertilisers or other agrochemical compounds are transported, stored and applied separately. The method described above avoids the need for separate transport, storage and application thereby reducing cost and complexity.

Other features described above may be used in the above method and are not repeated here for brevity. Method of broadcast

In a sixth aspect, there is provided a method of broadcasting a seed composition by:
selecting the seed composition substantially as described above;
storing the seed composition until ready for use; and
applying the seed composition onto or into a ground surface.

The seed composition may be broadcast directly to foliage or onto or into a substrate such as soil. Other features described above may be used in the above method and are not repeated here for brevity.

### Method of Seeding Land

In a seventh aspect, there is provided a method of seeding land comprising:
providing a volume of seed composition substantially as described above;
optionally, transporting and storing the seed composition; and
broadcasting the seed composition onto or into land to be seeded.

Other features described above may be used in the above method and are not repeated here for brevity.

### Moisture

Subsequent to broadcast, moisture may be added or moisture may be present already on or in the land to be seeded (i.e. the environment) to cause elution of the broadcast seed composition to the plant or soil.

Moisture may be in the form of irrigation or rain or even exposure to moisture in the soil or evening or morning dew.

Broadcast of the seed composition may be completed without co-application of water.

The inventor has found that morning dew or a small amount of rain e.g. 1 mm per 24 hours may be sufficient for the seed composition to elute and agrochemical to migrate from the seed composition and penetrate the surface of neighbouring vegetation roots or foliar growth.

### In-Direct Contact Via Soil Sufficient

It was found that even for herbicides that art suggests require foliar application for effective control, such as glyphosate for example, the described seed composition was unexpectedly effective, even if no direct contact with leaves/foliar plant material occurred. Art literature around herbicides like glyphosate teach that the herbicide is rapidly deactivated on contact with soil. As a result, foliar application is the common method of application. Without being bound by mechanism, it appears that the seed composition acts to preserve the agrochemical long enough in soil to ensure the agrochemical affects vegetation roots. The inventor found in this case that it was sufficient for the seed composition to be in contact or in very close proximity with any part of the plant (root, leaf, stem) to achieve an agrochemical effect (if agrochemical compound is used) and not just from foliar application.

The seed composition may provide a localised kill effect.

### Single Broadcast

In the above method, broadcasting may occur in one application of seed composition. That is, no additional broadcasts of seed, seed growth agents, supplements, fertilisers, or agrochemicals are required. In addition, it may be possible to avoid the need for labour before or post broadcast to clear vegetation about germinating seeds. As may be appreciated, this represents a considerable advantage over art methods through time and cost savings.

### Volume Broadcasted

The volume of seed composition broadcast may be based on the area of growing substrate to be controlled and/or the volume of soil to be conditioned and/or the density of subsequent vegetative growth desired.

### Substrate

The ground surface referred to above may be a growing substrate which may be agricultural land.

The ground surface may be flat land, undulating land or hill country.

Hill country may be defined as being land with slopes above 5, or 6, or 7, or 8, or 9, or 10, or 11, or 12, or 13, or 14, or 15, or 16, or 17, or 18, or 19, or 20 degrees. By contrast, flat land or undulating land may be defined as having slopes of 5 degrees or less.

Hill country for the purposes of a temperate climate akin to that seen in New Zealand may be land located at levels below approximately 1000 m above sea level.

Whilst hill country is referred to above, the method may be used on flat land or land with lower slope angles than that described for hill country.

### Broadcast Method

Broadcast may be completed via art methods and apparatus. For example, broadcast may be from the ground or by aerial methods and no special handling measures are required.

### Advantages

As noted above, the seed composition and related methods of manufacture and use may provide a number of advantages over the art. Whilst not limited to one or more of the following, selected advantages may include:

Providing a seed with dual activity product (or even triple activity product) applied in one application e.g. herbicide and fertiliser (dual) or herbicide, fertiliser and slugicide (triple);
Ease of shipping and storage;
Agrochemicals such as herbicides are used at rates that are approved and do not exceed Maximum Residue Level (MRL) established by regulatory authorities;
Due to optional dry application, greater broadcast control occurs with no agrochemical drift to undesired vegetation or area;
The seed composition may be applied at any time including when rainfall is expected. There is no need for rain-fastness;
Application may be completed in areas with limited water supplies.
The seed composition allows for propagation of large numbers of seeds over a wide area and in challenging locations;
There may be no post broadcast maintenance unlike in the art when seeds may be applied and weeding needed post broadcast;
There is no need to separately apply agrochemical compound to a site pre seed broadcast;
Labour and transport costs may be minimised through a reduction in the number of applications needed due to co-administration;
Excellent seed propagation/germination rates result from the seed composition;
By using a hydrogel forming agent, the inventor has found it easier to address different seed sizes as the hydrogel forming agent is less dense compared to common encrusting agents and increases the size of smaller seeds such plantain or clover without affecting the overall seed composition weight to a detrimental extent;
When subjected to water on swelling the hydrogel forming agent “pushes” most of the plant seeds away and this movement of seed decreases seed exposure to agrochemical compound (if included);
By using a non-aqueous binding-coating ingredient, the process of manufacturing with hydrogel forming agent is easier, as, on contact with hydrogel forming agent, the binders prevent premature swelling of the hydrogel forming agent. Premature swelling may complicate the manufacturing process of obtaining uniform particles and requires more drying force to remove all moisture and deflate swelled hydrogel forming agent to an original size;
The seed composition at least when dried is anticipated to be storage stable for 2 or more years;
The seed composition when dried avoids dusting issues or loss of seed coating or seed coatings during storage and handling; and
The seed composition avoids or at least minimises run off of agrochemical compound into waterways.

The embodiments described above may also be said broadly to consist in the parts, elements and features referred to or indicated in the specification of the application, individually or collectively, and any or all combinations of any two or more said parts, elements or features.

Further, where specific integers are mentioned herein which have known equivalents in the art to which the embodiments relate, such known equivalents are deemed to be incorporated herein as if individually set forth.

### WORKING EXAMPLES

The above described seed composition and related methods of manufacture and use are now described by reference to specific examples.

### Example 1

To demonstrate the layered nature of the seed composition described herein, a dry seed composition was manufactured and the stylised image prepared as shown in FIG. 1 with part of the exterior removed to show the interior structure arrow 1.

In FIG. 1, the core comprises the plant seed 2, the plant seed 2 has a seed first coating layer 3 uniformly around the seed 2 to form a first coated seed 2. The first coated seed 2 is then further coated in a second coating comprising an amphiphilic compound 4 to form an amphiphilic 4 coated seed 2 and seed coating 3 (seed with a first coating and a second coating). This amphiphilic 4 coated seed 2 and seed coating 3 is then mixed with hydrogel 5 and the hydrogel 5 and amphiphilic 4 coated seed 2 and seed coating 3 is then further coated uniformly with a layer of an agrochemical compound 6 such as a herbicide. As shown in FIG. 1, the various layers (seed coating, amphiphilic coating an agrochemical coating) are all separate discrete layers that are not homogenous or blended together.

While a circular shape is illustrated in FIG. 1, other shapes may also result, most likely governed by the initial shape of the seed although the coatings and hydrogel mixed in may also alter the overall seed composition shape.

### Example 2

In this example, selected seed compositions are illustrated comprising different compounds.

The examples below should be understood only as guideline formulations as actual compounds used may vary within the parameters described above. Further the seed compositions described below were all dried,

Seed Composition 1

| Compound | Function |
|---|---|
| Cocksfoot seeds 4 kg | Seed |
| White clover seeds 4 kg | Seed |
| Plantain seeds 2 kg | Seed |
| Peridiam Active 315 ™ 10 mL | Film coating agent |
| Lime 8 kg | Pelletising agent |
| Soy lecithin 0.1 kg | Amphiphilic agent |
| Potassium polyacrylate 2 kg | Hydrogel |
| Glyphosate 600 g/L soluble concentrate 2L | Agrochemical (optional) |

Seed Composition 2

| Compound | Function |
|---|---|
| White clover seeds 4 kg | Seed |
| Plantain seeds 2 kg | Seed |
| Peridiam Active 109 ™ 10 mL | Film coating agent |
| Kaolin clay 5 kg | Pelletising agent |
| Polyvinyl alcohol 1.5% solution | Binding agent |
| Phosphatidylositol 0.05 kg | Amphiphilic agent |
| Polyaspartic acid 3 kg | Hydrogel |
| Gelatin 1 kg | Hydrogel |
| Met 600 170 g (herbicide, metsulfuron-methyl | Agrochemical (optional) |
| 600 g/kg WDG) | |

Seed Composition 3

| Compound | Function |
|---|---|
| Ryegrass seeds 20 kg | Seed |
| White clover seeds 4 kg | Seed |
| Plantain seeds 2 kg | Seed |
| Hydroxypropyl methylcellulose 25 g | Film coating agent |
| Bentonite clay 26 kg | Pelletising agent |
| Polyvinyl acetate 1% solution | Binding agent |
| Molybdenum superphosphate 30 g | Supplement |
| Keyrole Pro ™ 117 mL | Insecticide coating |
| Ammonium phosphatidyl rapeseedate 0.25 kg | Amphiphilic agent |
| Starch 2 kg | Hydrogel |
| Sodium polyacrylate 2 kg | Hydrogel |
| Sodium alginate 2 kg | Hydrogel |
| Broadleaf Kill 2,4-D 2L (herbicide, 680 g/L | Agrochemical (optional) |
| 2,4-D a.e. emulsifiable concentrate) | |

Seed Composition 4

| Compound | Function |
|---|---|
| Rape seed 1.5 kg | Seed |
| Turnip 1 kg | Seed |
| Plantain seeds 2 kg | Seed |
| Seedguard ™ 20.5 mL | Film coating agent |
| Kaolin clay 1 kg | Pelletising agent |
| Methocel 5% solution | Binding agent |
| Bentonite 3 kg | Pelletising agent |
| Peat inoculant 45 g | Inoculant |
| Zinc sulphate 4.5 g | Mineral supplement |
| Ammonium phosphatidyl rapeseedate 0.25 kg | Amphiphilic agent |
| Potassium polyacrylate 85 kg | Hydrogel |
| Sodium alginate 5 kg | Hydrogel |
| Flumetsulam 800 65 g (herbicide, 800 g/kg | Agrochemical (optional) |
| flumetsulam WDP) | |

### Example 3

The manufacturing process of the seed composition can be provided as the following step:
Selecting the seed mix;
Coating the seed mix with coating film or binding agent/pelletising agent and other additives as required (mineral supplements, biological and chemical additives, etc.);
Coating formed coated seeds with amphiphilic compound;
Mixing the formed coated seeds with hydrogel forming compound to form a seed composition;
Optionally coating formed mixture with agrochemical ingredient; and
Optionally, drying the formed mix to remove moisture.

### Example 4

In this example, the above method was used and the final product illustrated.
1. Seed mix consisting of 4 kg cocksfoot, 4 kg white clover and 2 kg plantain, was placed into the pan granulator and coated with 100 ml 10% solution of Seedguard™.
2. The 8 kg of lime was applied to pelletise the coated seeds;
3. The pelletised seeds were coated with 0.1 kg of soy lecithin;
4. 2 kg of potassium polyacrylate granules were crushed to the size close to pelletised seeds and mixed with coated seed's mix;
5. 2L of Grunt™ 600 glyphosate soluble concentrate was sprayed on the formed mixture under constant mixing.
6. The formed mix was dried with hot air till constant weight.

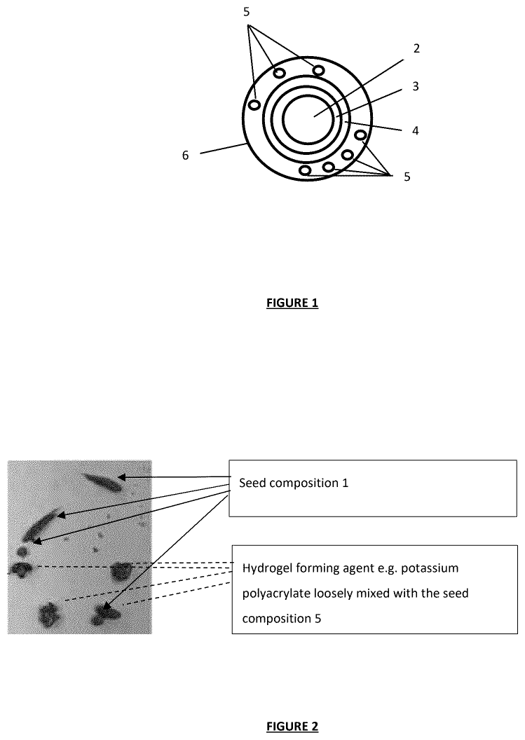

The final dry seed composition is shown in the photograph in FIG. 2. As shown, the hydrogel forming agent may not be entirely bound with the seed composition and may be bound by the coatings of the seed composition or loosely mixed with the seed composition, still with at least agrochemical coating thereon

### Example 5

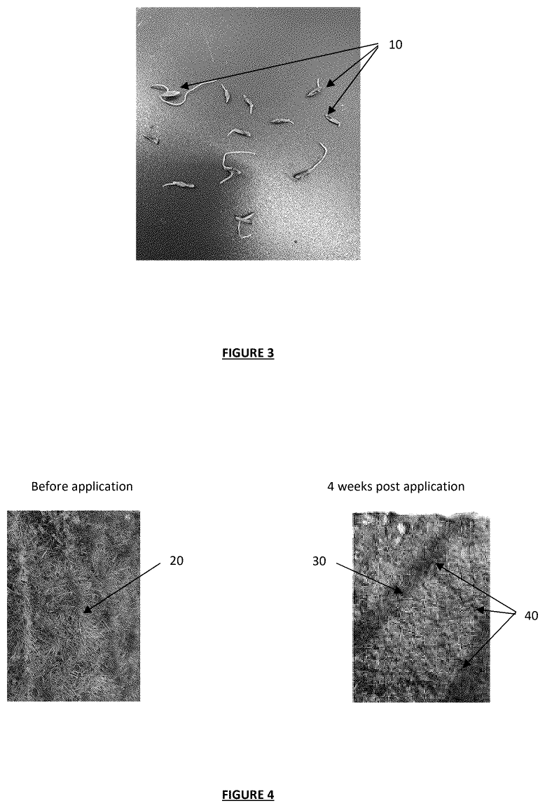

A growing trial was completed to illustrate the rate of seed germination from the seed composition. A sample of composition obtained from Example 4 was placed on the wetted paper towels, covered with another layer of paper towels and wrapped in foil to prevent light penetration. After 10 days, seeds 10 were removed and percentage of germinated seeds was established. The results are shown in the photograph in FIG. 3. It was found that all seeds 10 germinated (100% germination), which provides evidence there was no effect on seed 10 germination rate by herbicide.

### Example 6

A trial was completed to evaluate the performance of the seed composition in real conditions. Dry seed composition was applied to a ground substrate at a calculated rate to provide 10 kg grass seeds/ha. The dry seed composition was applied to an established grass area.

FIG. 4 shows photographs of the ground to which the dry seed composition was applied before broadcast (left) and 4 weeks post broadcast (right). The growth prior to broadcast (item 20 green lush grass) is killed after 4 weeks (item 30 brown dead grass) and there are signs of new growth (item 40 new green growth) at 4 weeks of newly germinated seed. This shows how the dry seed composition may be used to re-seed an existing area of ground.

### Example 7

In this example the influence of the hydrogel is illustrated.

A trial was completed by broadcasting dry seed composition described above to a ground substrate. As shown in the photograph shown in FIG. 5, the hydrogel forming agent 50 swells and retains moisture about the seeds and within the grass 60 supporting seed germination post broadcast. The hydrogel forming agent 50 absorb moisture in the field.

### Example 8

A further example is provided to show the impact of hydrogel in the seed composition.

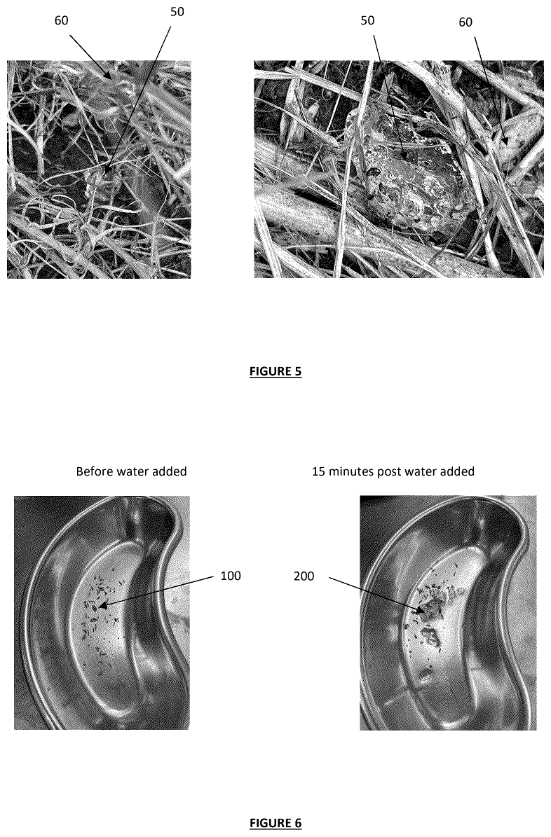

In this example, and as shown in the photograph of FIG. 6, a sample of the seed composition 100 from Example 5 was placed in a steel container and potable water was added. The photograph on the left of FIG. 6 shows the seed composition 100 prior to addition of potable water while the photograph on the right shown the seed composition 200 and potable water combination approximately 15 minutes after water exposure. The area covered by the mixture more than doubled post water addition.

### Example 9

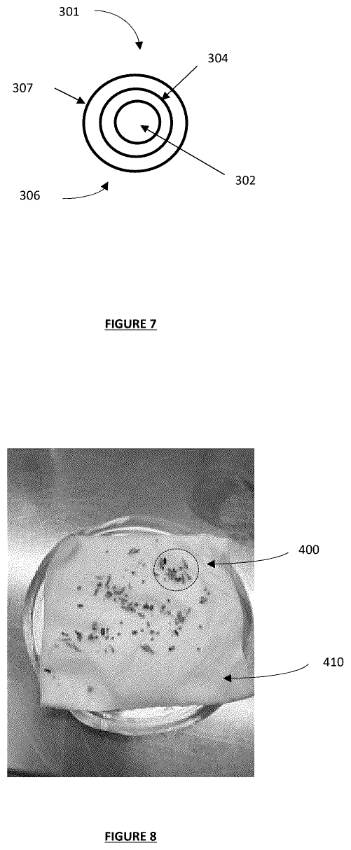

To demonstrate the layered nature of an alternative embodiment of seed composition described herein, a dry seed composition was manufactured and the stylised image prepared as shown in FIG. 7 with part of the exterior removed to show the interior structure arrow 301.

In FIG. 7, the core comprises the plant seed 302, the plant seed 302 has an amphiphilic first coating 304 uniformly coated around the seed 302 to form a coated pellet or granule 306. The coated pellet or granule 306 is then further coated (second coating 307) with a homogeneous powder mixture comprising: pelletiser, hydrogel forming agent and optionally, an agrochemical compound if used. As shown in FIG. 7, the first and second coatings are separate discrete layers that are not homogenous or mixed together.

Also, while a circular shape is illustrated in FIG. 7, other shapes may also result, most likely governed by the initial shape of the seed although the coatings and hydrogel mixed in may also alter the overall seed composition shape.

### Example 10

In this example, the above seed composition is described in terms of the overall composition and method of manufacture.

In regards to the final seed composition itself, the seed composition may be similar to those described in Example 2 above where the one key difference is the use of varying coating compounds and not necessarily different amounts of the different compounds. For example, Seed Compositions 5 and 6 below are substantially similar to Seed Compositions 1 and 2 above. This alternative approach of seed composition may also remove the need for a seed coating.

Seed Composition 5

| Compound | Function |
|---|---|
| Cocksfoot seeds 4 kg | Seed |
| White clover seeds 4 kg | Seed |
| Plantain seeds 2 kg | Seed |
| Soy lecithin 0.1 kg | Amphiphilic agent |
| Lime 8 kg | Pelletising agent |
| Potassium polyacrylate 2 kg | Hydrogel |
| Glyphosate 600 g/L soluble concentrate 2L | Agrochemical (optional) |

Seed Composition 6

| Compound | Function |
|---|---|
| White clover seeds 4 kg | Seed |
| Plantain seeds 2 kg | Seed |
| Phosphatidylositol 0.05 kg | Amphiphilic agent |
| Kaolin clay 5 kg | Pelletising agent |
| Polyaspartic acid 3 kg | Hydrogel |
| Gelatin 1 kg | Hydrogel |
| Met 600 170 g (herbicide, metsulfuron-methyl | Agrochemical (optional) |
| 600 g/kg WDG) | |

One example of a method of manufacturing the above seed compositions may be as follows:
Bare seeds are covered as a first coating by amphiphilic compound. The amphiphilic compound may be selected to be non-foaming, practically water free, preferably of natural origin, and with at least some emulsifying properties.
Then separately preparing a second coating by:
   mixing lime with potassium polyacrylate;
   spraying a herbicide solution over the mix of lime and potassium polyacrylate;
   forming a cake of the above and leaving the cake to dry, then milling the cake to obtain a fine powder;
Applying the above fine power as a second coating to the first coating;
Drying the coated seed composition to form a dry seed composition.

In this example, there is a clear (second) layer of hydrogel forming agent.

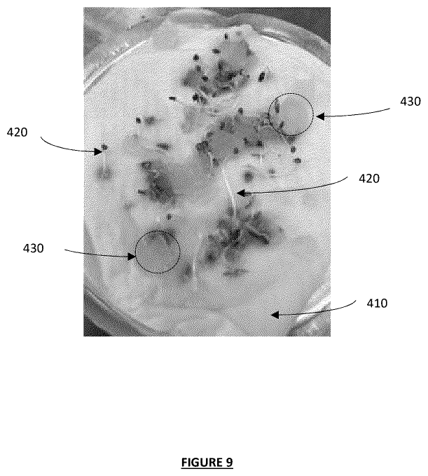

When mixed with water, the hydrogel forming agent swells and, on swelling, the hydrogel forming agent form blobs that “push” most of the grass seed away. This movement appears to decreases seed exposure to herbicide. FIG. 8 is a photograph from a trial completed which shows the above seed composition 400 at day 0 when placed on a water retaining paper 410 substrate. FIG. 9, shows the same seed composition after 4 days of exposure to moist conditions on the water retaining paper 410. As can be seen in FIG. 9, germination of seed 420 can be observed along with movement of the seeds 420 from the blobs 430 of hydrogel formed by the hydrogel forming agent.

Aspects of the seed composition and related methods of manufacture and use have been described by way of example only and it should be appreciated that modifications and additions may be made thereto without departing from the scope of the claims herein.

What is claimed is:

1. A seed composition comprising:
seed from a plant;
a first coating on the seed, the first coating comprising: a pelletising agent and optionally also a film coating agent, a binding agent or both a film coating agent and a binding agent;
a second coating over the first coating, the second coating comprising an amphiphilic compound, the second coating configured to form a discrete layer over the first coating, the amphiphilic compound configured to delay release of the first coating and seed from the seed composition, post application/broadcast of the seed composition to a substrate; and
hydrogel forming agent, the hydrogel forming agent being a separate component mixed with but not embedded in the first coating or the second coating; and
wherein:
the first coating does not comprise any amphiphilic compound, and
the second coating does not comprise a film coating agent, a binding agent, or a pelletising agent.

2. The seed composition as claimed in claim 1 wherein, the seed composition further comprises:
an agrochemical compound, the agrochemical compound having herbicide, fungicide, or insecticide properties; and,
wherein the agrochemical compound forms a third coating over the second coating of the seed composition.

3. (canceled)

4. The seed composition as claimed in claim 2 wherein the first coating and the second coating of the seed composition do not comprise an agrochemical compound.

5. The seed composition as claimed in claim 1 wherein the binding agent is selected from: modified cellulose, polyvinyl pyrrolidone, polyvinyl alcohol, and combinations thereof.

6. A seed composition comprising:
seed from a plant;
a first coating on the seed, the first coating comprising an amphiphilic compound, the seed and first coating forming a coated pellet or granule; and
a second coating over the first coating, the second coating comprising: a pelletising agent and a hydrogel forming agent, the second coating being a discrete layer over the first coating; and
wherein:
the first coating does not comprise a pelletising agent or a hydrogel forming agent; and
the second coating does not comprise an amphiphilic compound.

7. The seed composition as claimed in claim 6 wherein, the seed composition further comprises:
an agrochemical compound, the agrochemical compound having herbicide, fungicide, or insecticide properties; and,
wherein the agrochemical compound is mixed with the pelletising agent and the hydrogel forming agent of the second coating and wherein the agrochemical compound forms part of the second coating.

8. (canceled)

9. The seed composition as claimed in claim 7 wherein the first coating does not comprise an agrochemical compound.

10. (canceled)

11. (canceled)

12. The seed composition as claimed in claim 1 wherein the hydrogel forming agent is selected from: cellulose, starch, chitosan, gelatine, collagen, alginate, and combinations thereof.

13. The seed composition as claimed in claim 1 wherein the hydrogel forming agent is selected from polymers based on polyacrylic acid and polyacrylamide.

14. A method of manufacturing a seed composition by:
selecting seed from a plant;
coating the seed with a first coating, the first coating comprising: a pelletising agent and optionally also a film coating agent, a binding agent or both a film coating agent and a binding agent and wherein the first coating does not comprise an amphiphilic compound;
coating the seed with a second coating over the first coating, the second coating comprising an amphiphilic compound to form a double coated seed and wherein the second coating does not comprise a film coating agent, a binding agent, or a pelletising agent; and
providing a hydrogel forming agent and mixing the hydrogel forming agent with the double coated seed, the hydrogel forming agent mixed with but not embedded in the first coating or the second coating on the seed.

15. The method as claimed in claim 14 wherein the seed composition is dried to form a dry seed composition and wherein, prior to drying, the method further comprises coating the second coating of the seed composition with a third coating, the third coating comprising an agrochemical compound.

16. (canceled)

17. A method of manufacturing a seed composition by:
selecting seed from a plant;
coating the seed with a first coating, the first coating comprising an amphiphilic compound and wherein the first coating does not comprise a pelletising agent or a hydrogel forming agent; and
coating the seed with a second coating over the first coating, the second coating comprising a pelletising agent and a hydrogel forming agent the second coating forming a discrete layer over the first coating and wherein the second coating does not comprise an amphiphilic compound.

18. The method as claimed in claim 17 wherein the seed composition is dried to form a dry seed composition.

19. The method as claimed in claim 18 wherein, prior to drying, the method further comprises coating the second coating of the seed composition, with a third coating, the third coating comprising at least one agrochemical compound.

20. A method of shipping, or storing, or shipping and storing, a seed composition by:
forming the seed composition as claimed in claim 1 and, optionally drying the seed composition; and
shipping, or storing, or shipping and storing, the seed composition in a dry state.

21. A method of broadcasting a seed composition by:
selecting the seed composition as claimed in claim 1;
storing the seed composition until ready for use; and
applying the seed composition onto or into a ground surface.

22. A method of seeding land comprising:
providing a volume of seed composition as claimed in claim 1;
optionally, transporting and storing the seed composition; and
broadcasting the seed composition onto or into land to be seeded.

23. The method as claimed in claim 22 wherein, subsequent to broadcast, moisture is added or moisture is present already on or in the land to be seeded to cause elution of the broadcast seed composition to the plant or soil.

24. A seed composition comprising:
seed from a plant;
a first coating on the seed, the first coating comprising: a pelletising agent and optionally also a film coating agent, a binding agent or both a film coating agent and a binding agent;
a second coating over the first coating, the second coating comprising an amphiphilic compound, the second coating configured to form a discrete layer over the first coating, the amphiphilic compound configured to delay release of the first coating and seed from the seed composition, post application/broadcast of the seed composition to a substrate;
a third coating over the second coating of the seed composition, the third coating comprising an agrochemical compound with herbicide properties; and
hydrogel forming agent, the hydrogel forming agent being a separate component mixed with but not embedded in the first coating or the second coating or the third coating

25. (canceled)

26. A seed composition comprising:
seed from a plant;
a first coating on the seed, the first coating comprising an amphiphilic compound, the seed and first coating forming a coated pellet or granule and wherein the first coating does not comprise an agrochemical compound;
a second coating over the first coating, the second coating comprising: a pelletising agent and a hydrogel forming agent, the second coating being a discrete layer over the first coating;
an agrochemical compound having herbicide properties wherein, the agrochemical compound is mixed with the pelletising agent and the hydrogel forming agent of the second coating and wherein the agrochemical compound forms part of the second coating.

27. (canceled)
